(19) United States
(12) Patent Application Publication
(10) Pub. No.: US 2009/0310222 A1
(43) Pub. Date: Dec. 17, 2009

(54) MULTILAYER OPTICAL FILM STRUCTURES HAVING IMPROVED PROPERTIES AND THE USE THEREOF

(75) Inventors: Heinz Pudleiner, Krefeld (DE); Klaus Meyer, Dormagen (DE); Joerg Nickel, Dormagen (DE); Hans Braun, Rayong (TH)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/481,162

(22) Filed: Jun. 9, 2009

(30) Foreign Application Priority Data
Jun. 11, 2008 (EP) 08010562.0

(51) Int. Cl. G02B 1/04

(52) U.S. Cl. 359/599; 359/625

(57) ABSTRACT

The present invention relates to an optical film structure having improved properties and comprising at least one prism film and/or diffuser film as well as a multilayer optical film, wherein the multilayer optical film has at least one top film having an outer layer directed towards the prism film and/or diffuser film and made from a plastics composition containing a transparent thermoplastic and at least one quaternary ammonium salt of a perfluoroalkylsulfonic acid as lubricant additive. According to the invention the outer layer has at least one coefficient of sliding friction of <0.30 relative to the prism film and/or diffuser film measured in accordance with ASTM D 1894-06, with a roughness R3z of >5 μm (R3z in accordance with ISO 4288). The invention also provides a backlight unit containing the improved film structure and the use of the optical film structure according to the invention for liquid crystal screens.

### RELATED APPLICATIONS

This application claims benefit to European Patent Application No. 08010562.0, filed Jun. 11, 2008, which is incorporated herein by reference in its entirety for all useful purposes.

### BACKGROUND OF THE INVENTION

The present invention relates to multilayer optical film structures having improved properties and the use thereof in liquid crystal displays (LCDs).

Multilayer film composites, in particular multilayer optical films, are becoming increasingly important owing to a large number of commercial applications. One area of application is in liquid crystal screens. These substantially contain two components: the backlight unit, in which the light is generated and is modified by various optical layers, and the LCD (liquid crystal display). This contains red, green and blue coloured filters and liquid crystals, which are activated alternately by fine current pulses and allow the light to pass through.

In principle, a backlight unit (BLU) with a direct light system in an LCD has the structure described below. It generally consists of a housing in which, depending on the size of the backlight unit, a varying number of fluorescent tubes, known as CCFLs (cold cathode fluorescent lamps), are arranged. The inside of the housing has a light-reflective surface. A diffuser sheet, which has a thickness of 1 to 3 mm, preferably a thickness of 2 mm, lies on top of this lighting system. On top of the diffuser sheet is a set of plastic films, which optimise the light yield. The diffuser film like the diffuser sheet scatters the light uniformly, such that the striped pattern of the fluorescent tubes blurs. A homogeneous illumination can be achieved in this way. This is followed by a prism film or brightness enhancing film (BEF). Its surface is textured in such a way that incident light falling from various directions is oriented directly forwards towards the LCD. On top of the prism film there is usually another optical film known as a dual brightness enhancing film (DBEF). The DBEF allows only exactly linearly polarised light, which can be utilised by the crystals in the LCD, to pass through. Light with any other orientation is reflected back at the DBEF to the reflective surface of the inside of the housing, from where it is once again reflected forward towards the DBEF. In this way the DBEF increases the yield of correctly polarised light and hence the efficiency of the BLU. The linearly polarising film lies directly under the LC display on top.

Light-scattering plastics compositions which can be used for diffuser sheets and diffuser films in flat screens are described for example in WO 2007/039130 A1 and in WO 2007/039131 A1.

Reflective polarisers (DBEFs) are known in the prior art. In WO 1996/19347, for example, multilayer optical films are described as reflective polarisers.

In this patent and in U.S. Pat. No. 5,783,283 and WO 1997/32726 it is also stated that, in particular, composites having alternating layers of polyethylene naphthalate (PEN) and polyethylene terephthalate (PET) can have a higher stretch ratio than monolithic films made from either PET or PEN. It is additionally disclosed that the degree of surface roughness, the haze and the coefficient of friction are controllable and can be adjusted through the use of a semicrystalline thermoplastic as a film layer, even in the absence of an additional lubricant. The mechanical properties and the processability of the films can be improved in this way.

The area of application places high demands on the processability and other properties of the optical films. For example, undesirable scratches on the surface of the DBEF or damage to the prism film or diffuser film can occur during superposition of the films in the assembly of a backlight unit or during transport.

Since in a conventional film structure in a BLU the DBEF is laid on the peaks of the prism film, abraded matter produced during scratching can reduce the optical performance of the prism films since the abraded matter collects in the grooves of the ribbed prism structure. In addition, the light directing function of the prism film is critically influenced by the shape of the peaks. The rubbing of the DBEF film on the prism film can abrade the peaks and hence in turn reduce the quality and performance of the prism film.

The object underlying the invention is therefore to provide an optical film structure which eliminates the stated problems and has improved properties.

### EMBODIMENTS OF THE INVENTION

An embodiment of the present invention is a film structure comprising at least one prism film and/or diffuser film and a multilayer optical film, wherein said multilayer optical film comprises at least one top film having an outer layer which is directed towards said at least one prism film and/or diffuser film and is prepared from a plastics composition comprising a transparent thermoplastic and at least one quaternary ammonium salt of a perfluoroalkylsulfonic acid as lubricant additive, wherein said outer layer has at least one coefficient of sliding friction of less than 0.30 relative to said at least one prism film and/or diffuser film measured in accordance with ASTM D 1894-06, with a roughness R3z of greater than 5 μm measured in accordance with ISO 4288.

Another embodiment of the present invention is the above film structure, wherein said at least one prism film has a prism structure oriented towards said multilayer optical film and the outer layer of said multilayer optical film has a coefficient of sliding friction of less than or equal to 0.25 parallel to said prism structure of said at least one prism film and a coefficient of sliding friction of less than or equal to 0.30 transversely to said prism structure of said at least one prism film, measured in each case in accordance with ASTM D 1894-06, with a roughness R3z of greater than 5 μm (R3z in accordance with ISO 4288).

Another embodiment of the present invention is the above film structure, wherein said multilayer optical film comprises an optical base film comprising a multilayer consisting of naphthalene dicarboxylic acid and/or terephthalic acid polyester.

Another embodiment of the present invention is the above film structure, wherein said plastics composition contains from 96 to 99.89 weight % of a transparent thermoplastic and from 0.001 to 4.0 weight % of quaternary ammonium salts of perfluoroalkylsulfonic acids as lubricant additive, wherein the total weight % of these components equals 100 weight %.

Another embodiment of the present invention is the above film structure, wherein said transparent thermoplastic is selected from the group consisting of polyacrylates, polymethacrylates, cycloolefin copolymers, polysulfones, polystyrenes, poly-alpha-methyl styrenes, polyesters, polycarbonates, polycarbonate/polyester blends, polycarbonate/polycyclohexyl methanol cyclohexane dicarboxylate, and polycarbonate/PBT.

Another embodiment of the present invention is the above film structure, wherein one or more of said at least one quaternary ammonium salt of a perfluoroalkylsulfonic acid is of formula (I)

R—SO₃NR′R″R′″R″″ (1)

is used as the lubricant additive, wherein
R is perfluorinated cyclic or linear, branched or unbranched carbon chains having 1 to 30 carbon atoms;
R′ is unsubstituted or halogen-, hydroxy-, cycloalkyl-, or alkyl-substituted, cyclic or linear, branched or unbranched carbon chains having 1 to 30 carbon atoms; and
R″, R′″, and R″″
   are, independent of each other, cyclic or linear, branched or unbranched carbon chains having 1 to 30 carbon atoms optionally substituted with halogen, hydroxy, cycloalkyl, or alkyl.

Another embodiment of the present invention is the above film structure, wherein said at least one quaternary ammonium salt of a perfluoroalkylsulfonic acid is selected from the group consisting of:
perfluorooctanesulfonic acid tetrapropylammonium salt,
perfluorobutanesulfonic acid tetrapropylammonium salt,
perfluorooctanesulfonic acid tetrabutylammonium salt,
perfluorobutanesulfonic acid tetrabutylammonium salt,
perfluorooctanesulfonic acid tetrapentylammonium salt,
perfluorobutanesulfonic acid tetrapentylammonium salt,
perfluorooctanesulfonic acid tetrahexylammonium salt,
perfluorobutanesulfonic acid tetrahexylammonium salt,
perfluorobutanesulfonic acid trimethyl neopentylammonium salt,
perfluorooctanesulfonic acid dimethyl diisopropylammonium salt,
perfluorooctanesulfonic acid trimethyl neopentylammonium salt,
perfluorobutanesulfonic acid dimethyl dineopentylammonium salt,
perfluorooctanesulfonic acid dimethyl dineopentylammonium salt,
N-methyl tripropylammonium perfluorobutyl sulfonate,
N-ethyl tripropylammonium perfluorobutyl sulfonate,
tetrapropylammonium perfluorobutyl sulfonate,
dimethyl diisopropylammonium perfluorobutyl sulfonate,
N-methyl tributylammonium perfluorooctyl sulfonate,
cyclohexyldiethylmethylammonium perfluorooctyl sulfonate, and
cyclohexyltrimethylammonium perfluorooctyl sulfonate.

Another embodiment of the present invention is the above film structure, wherein said at least one quaternary ammonium salt of a perfluoroalkylsulfonic acid is diisopropyl dimethylammonium perfluorobutyl sulfonate.

Another embodiment of the present invention is the above film structure, wherein said multilayer optical film has a thickness of from 50 μm to 1000 μm.

Another embodiment of the present invention is the above film structure, wherein said outer layer of said multilayer optical film has a thickness of from 1 μm to 150 μm.

Another embodiment of the present invention is the above film structure, wherein said top film comprises at least one coextruded layer in addition to said outer layer.

Another embodiment of the present invention is the above film structure, wherein said coextruded layer has a thickness of from 10 μm to 100 μm.

Yet another embodiment of the invention is a backlight unit for a liquid crystal screen comprising the above film structure.

Yet another embodiment of the invention is an optical film set for a flat screen comprising the above film structure.

### DESCRIPTION OF THE INVENTION

This object is achieved according to the invention by a film structure according to claim 1, which comprises at least one prism film and/or diffuser film as well as a multilayer optical film, wherein the multilayer optical film has, directed towards the prism film and/or the diffuser film, at least one top film having an outer layer made from a plastics composition containing a transparent thermoplastic and quaternary ammonium salts of perfluoroalkylsulfonic acids as lubricant additive, and the outer layer has at least one coefficient of sliding friction of <0.30 relative to the prism film and/or diffuser film measured in accordance with ASTM D 1894-06, with a roughness R3z of >5 μm (R3z in accordance with ISO 4288).

Such a film structure according to the invention has particularly good producibility and processability, together with an outstanding resistance to scratches and damage. In this way the number of defective products can be reduced markedly and their durability extended. In particular the optical performance and quality of the film structure can be improved.

In a preferred embodiment the prism film has a prism structure oriented towards the outer layer of the multilayer optical film and the outer layer of the multilayer optical film has a coefficient of sliding friction of ≦0.25 parallel to the prism structure of the prism film and a coefficient of sliding friction of ≦0.30 transversely to the prism structure of the prism film, measured in each case in accordance with ASTM D 1894-06, with a roughness R3z of >5 μm (R3z in accordance with ISO 4288).

Surprisingly it was found that with this embodiment of the film structure according to the invention its properties could be further improved. Such a film structure in which the orientation of the prism structure of the prism film is taken into account in adjusting the coefficient of sliding friction of the multilayer optical film exhibits a further improved processability and resistance to scratches or damage in the film composite. The light directing function of the prism film in a film structure according to the invention is advantageously particularly good and the quality and optical performance are retained for significantly longer than in film structures of the prior art due to the reduced abraded matter.

According to the invention any film which can orient incident light falling from various directions in a particular direction due to its textured surface and is suitable as a brightness enhancing film (BEF) in LCDs can be used as a prism film. The surface of the prism film has a structure comprising alternating grooves and peaks.

The multilayer optical film according to the invention preferably comprises as the optical part a multilayer extrudate, which can be produced for example in accordance with patent specification U.S. Pat. No. 5,783,28 or laid-open patent applications WO 97/32726 or WO 96/19347. The optical part can preferably be a multilayer consisting of naphthalene dicarboxylic acid polyester and terephthalic acid polyester. According to the invention this optical part is also described as the base film or base layer. According to the invention at least one thermoplastic film is laminated to the base film as a top film. According to the invention a textured thermoplastic film is preferably laminated to each side of the base film as a top film, such that a sandwich-type structure is formed.

The multilayer optical films according to the invention can be used particularly advantageously for example as reflective polariser films (known as dual brightness enhancement films (DBEFs)) in liquid crystal displays (LCDs).

According to the invention the thermoplastic top film can have a single-layer or multilayer structure. If the top film has a single-layer structure, the top film corresponds according to the invention to the outer layer. If the top film has a multilayer structure, through coextrusion for example, the outermost film layer oriented towards the prism film and/or diffuser film is described as the outer layer. The outer layer oriented towards the prism film has a coefficient of sliding friction of ≦0.25 parallel to the prism structure of the prism film and a coefficient of sliding friction of ≦0.30 transversely to the prism structure of the prism film, measured in each case in accordance with ASTM D 1894-06, at a roughness R3z of >5 μm (R3z in accordance with ISO 4288).

According to the invention “transversely to the prism structure” is understood to mean that the orientation is perpendicular, i.e. at 90°, to the grooves and peaks formed by the prismatic ribs of the prism film. According to the invention “parallel to the prism structure” is understood to mean that the orientation is parallel to the grooves and peaks of the prismatic ribs.

In a preferred embodiment the outer layer can consist of a plastics composition containing 96 to 99.89 wt. % of a transparent thermoplastic and 0.001 to 4.0 wt. % of quaternary ammonium salts of perfluoroalkylsulfonic acids as lubricant additive, the stated components adding to 100 wt. % in each case. The perfluoroalkylsulfonic acid ammonium salts as lubricant additive are preferably added in amounts of 0.01 to 4 wt. %, preferably 0.05 to 2 wt. %, most particularly preferably 0.1 to 0.5 wt. %.

All transparent thermoplastics are suitable as plastics for the outer layer of the multilayer optical film: for example, polyacrylates, polymethacrylates, cycloolefin copolymers (COC), polysulfones (PSU), polystyrenes (PS), poly-alpha-methyl styrenes (MS), polyesters, such as for example polyethylene terephthalate (PET), polyethylene terephthalate copolymers (PETG) or polyethylene naphthalate (PEN), polycarbonates, polycarbonate/polyester blends (PC/PET), polycarbonate/polycyclohexyl methanol cyclohexane dicarboxylate (PCCD), polycarbonate/polybutylene terephthalate (PBT) can be used.

Polycarbonates are preferably used for the production of the outer layer. All known polycarbonates can be used here. These can be homopolycarbonates, copolycarbonates and thermoplastic polyester carbonates, for example.

The polycarbonates preferably have a weight-average molecular weight M_{w} of 18,000 to 40,000, preferably 26,000 to 36,000, and particularly preferably 28,000 to 35,000, determined by measuring the relative solution viscosity in an Ubbelohde viscometer at 25° C. in dichloromethane or in mixtures of equal amounts by weight of phenol/o-dichlorobenzene, calibrated by light scattering.

The polycarbonates can be produced by known methods, for example by the interfacial polycondensation process or the melt interesterification process.

The production of polycarbonates by the interfacial polycondensation process is variously described in the literature; reference is made by way of example to H. Schnell, Chemistry and Physics of Polycarbonates, Polymer Reviews, Vol. 9, Interscience Publishers, New York 1964 p. 33 ft, to Polymer Reviews, Vol. 10, “Condensation Polymers by Interfacial and Solution Methods”, Paul W. Morgan, Interscience Publishers, New York 1965, chapter Vm, p. 325, to Drs U. Grigo, K. Kircher and P. R. Müller “Polycarbonate” in Becker/Braun, Kunststoff-Handbuch, Vol. 3/1, Polycarbonate, Polyacetale, Polyester, Celluloseester, Carl Hanser Verlag Munich, Vienna 1992, p. 118-145, and to patent specification EP 0 517 044 A.

It is also possible to produce polycarbonates from diaryl carbonates and diphenols by the known polycarbonate process in the melt, known as the melt interesterification process, which is described for example in WO-A 01/05866 and WO-A 01/05867. Interesterification processes (acetate process and phenyl ester process) are also described for example in U.S. Pat. No. 3,494,885; U.S. Pat. No. 4,386,186; U.S. Pat. No. 4,661,580; U.S. Pat. No. 4,680,371 and U.S. Pat. No. 4,680,372, and in EP-A 26 120, EP-A 26 121, EP-A 26 684, EP-A 28 030, EP-A 39 845, EP-A 91 602, EP-A 97 970, EP-A 79 075, EP-A 14 68 87, EP-A 15 61 03, EP-A 23 49 13 and EP-A 24 03 01 and in DE-A 14 95 626.

Suitable diphenols are described for example in U.S. Pat. Nos. 2,999,835; 3,148,172; 2,991,273; 3,271,367; 4,982,014 and 2,999,846; in the German laid-open patent applications 1 570 703, 2 063 050, 2 036 052, 2 211 956 and 3 832 396, French patent specification 1 561 518, in the monograph “H. Schnell, Chemistry and Physics of Polycarbonates, Interscience Publishers, New York 1964, p. 28 ff; p. 102 ff”, and in “D. G. Legrand, J. T. Bendler, Handbook of Polycarbonate Science and Technology, Marcel Dekker New York 2000, p. 72 ff”.

Both homopolycarbonates and copolycarbonates can be used according to the invention. As one component for the production of copolycarbonates 1 to 25 wt. %, preferably 2.5 to 25 wt. % (relative to the total amount of diphenols to be used), of polydiorganosiloxanes having hydroxy-aryloxy end groups can also be used according to the invention. These are known for example from US patent specification U.S. Pat. No. 3,419,634 or can be produced by methods known from the literature. The production of polydiorganosiloxane-containing copolycarbonates is described for example in laid-open patent application DE 33 34 782 A.

Polyester carbonates and block copolyester carbonates can also be used according to the invention as thermoplastics, particularly those described in WO-A 2000/26275. Aromatic dicarboxylic acid dihalides for the production of aromatic polyester carbonates are preferably the diacid dichlorides of isophthalic acid, terephthalic acid, diphenyl ether-4,4′-dicarboxylic acid and naphthalene-2,6-dicarboxylic acid.

The aromatic polyester carbonates can be both linear and branched by known means, as described for example in DE 29 40 024 A and DE 30 07 934 A.

According to the invention one or more quaternary ammonium salts of a perfluoroalkylsulfonic acid having the formula (I)

R—SO₃NR′R″R′″R″″ (I)

can preferably be used as the lubricant additive, in which
R denotes perfluorinated cyclic or linear, branched or unbranched carbon chains having 1 to 30 carbon atoms, preferably 4 to 8 carbon atoms, in the case of cyclic radicals preferably those having 5 to 7 carbon atoms;
R′ denotes unsubstituted or halogen-, hydroxy-, cycloalkyl- or alkyl-substituted, in particular C₁ to C₃ alkyl- or C₅ to C₇ cycloalkyl-substituted, cyclic or linear, branched or unbranched carbon chains having 1 to 30 carbon atoms, preferably 3 to 10 carbon atoms, in the case of cyclic radicals preferably those having 5 to 7 carbon atoms, particularly preferably propyl, 1-butyl, 1-pentyl, hexyl, isopropyl, isobutyl, tert-butyl, neopentyl, 2-pentyl, isopentyl, isohexyl, cyclohexyl, cyclohexylmethyl and cyclopentyl;
R″, R′″ and R″″ each mutually independently denote unsubstituted or halogen-, hydroxy-, cycloalkyl- or alkyl-substituted, in particular C₁ to C₃ alkyl- or C₅ to C₇ cycloalkyl-substituted, cyclic or linear, branched or unbranched carbon chains having 1 to 30 carbon atoms, preferably 1 to 10 carbon atoms, in the case of cyclic radicals preferably those having 5 to 7 carbon atoms, particularly preferably methyl, ethyl, propyl, 1-butyl, 1-pentyl, hexyl, 1-isopropyl, isobutyl, tert-butyl, neopentyl, 2-pentyl, isopentyl, isohexyl, cyclohexyl, cyclohexylmethyl and cyclopentyl. A preferred selection are ammonium salts in which

R denotes perfluorinated linear or branched carbon chains having 1 to 30 carbon atoms, preferably 4 to 8 carbon atoms;

R′ denotes halogenated or non-halogenated linear or branched carbon chains having 1 to 30 carbon atoms, preferably 3 to 10 carbon atoms, with propyl, 1-butyl, 1-pentyl, hexyl, isopropyl, isobutyl, tert-butyl, neopentyl, 2-pentyl, isopentyl, isohexyl being particularly preferred;

R″, R′″ and R″″ each mutually independently denote halogenated or non-halogenated linear or branched carbon chains having 1 to 30 carbon atoms, preferably 1 to 10 carbon atoms, particularly preferably methyl, ethyl, propyl, 1-butyl, 1-pentyl, hexyl, isopropyl, isobutyl, tert-butyl, neopentyl, 2-pentyl, isopentyl, isohexyl.

Particularly preferred quaternary ammonium salts as lubricant additives within the meaning of the invention are:
Perfluorooctanesulfonic acid tetrapropylammonium salt,
Perfluorobutanesulfonic acid tetrapropylammonium salt,
Perfluorooctanesulfonic acid tetrabutylammonium salt,
Perfluorobutanesulfonic acid tetrabutylammonium salt,
Perfluorooctanesulfonic acid tetrapentylammonium salt,
Perfluorobutanesulfonic acid tetrapentylammonium salt,
Perfluorooctanesulfonic acid tetrahexylammonium salt,
Perfluorobutanesulfonic acid tetrahexylammonium salt,
Perfluorobutanesulfonic acid trimethyl neopentylammonium salt,
Perfluorooctanesulfonic acid dimethyl diisopropylammonium salt,
Perfluorooctanesulfonic acid trimethyl neopentylammonium salt,
Perfluorobutanesulfonic acid dimethyl dineopentylammonium salt,
Perfluorooctanesulfonic acid dimethyl dineopentylammonium salt,
N-Methyl tripropylammonium perfluorobutyl sulfonate,
N-Ethyl tripropylammonium perfluorobutyl sulfonate,
Tetrapropylammonium perfluorobutyl sulfonate,
Dimethyl diisopropylammonium perfluorobutyl sulfonate,
N-Methyl tributylammonium perfluorooctyl sulfonate,
Cyclohexyldiethylmethylammonium perfluorooctyl sulfonate,
Cyclohexyltrimethylammonium perfluorooctyl sulfonate.

According to the invention one or more of the aforementioned quaternary ammonium salts, in other words mixtures, can also be used as lubricant additives.

The lubricant additive(s) according to the invention are preferably selected from the group comprising

perfluorooctanesulfonic acid tetrapropylammonium salt,
perfluorooctanesulfonic acid tetrabutylammonium salt,
perfluorooetanesulfonic acid tetrapentylammonium salt,
perfluorooctanesulfonic acid tetrahexylammonium salt,
perfluorooctanesulfonic acid dimethyl diisopropylammonium salt, and
cyclohexyltrimethylammonium perfluorooctyl sulfonate, as well as the corresponding perfluorobutanesulfonic acid salts.

In a most particularly preferred embodiment of the invention, perfluorobutanesulfonic acid dimethyl diisopropylammonium salt is used as the lubricant additive.

Perfluoroalkylsulfonic acid ammonium salts are known or can be produced by known methods Production methods are described for example in WO-A 01/85869, DE 1 966 931 A or NL 7802 830.

Additional conventional polymer additives can optionally be included according to the invention in the plastics compositions of the films of the film structure according to the invention. For example, UV absorbers and conventional processing aids, in particular release agents and flow control agents, as well as, for example, known stabilisers for polycarbonates, in particular heat stabilisers, antistatics and/or optical brighteners, can be included. Different additives or concentrations of additives can be present in each film or layer.

The incorporation of lubricant additives and/or other aforementioned additives can take place by means of known processes. It can take place for example by mixing polymer pellets (polycarbonate) with the additives at temperatures of approximately 200 to 350° C. in units such as internal mixers, single-screw extruders and twin-shaft extruders, for example by melt compounding or melt extrusion, or by mixing the solutions of the polymer with solutions of the additives in suitable organic solvents such as CH₂CI₂, haloalkanes, haloaromatics, chlorobenzene and xylenes, with subsequent evaporation of the solvents by known means.

The proportion of additives in the plastics compositions can be varied within broad limits and is governed by the corresponding desired properties of the films.

In a further preferred embodiment of the invention the plastics composition of the outer layer can contain 0.01 to 0.5 wt. % of a UV absorber, relative to the total amount of plastics composition, selected from the classes of benzotriazole derivatives, dimeric benzotriazole derivatives, triazine derivatives, dimeric triazine derivatives, diaryl cyanoacrylates.

According to the invention phosphines, phosphites or Si-containing stabilisers and other compounds described in EP-A 0 500 496, for example, can be used as stabilisers Triphenyl phosphites, diphenylalkyl phosphites, phenyldialkyl phosphites, tris(nonylphenyl)phosphite, tetrakis-(2,4-di-tert-butylphenyl)-4,4′-biphenylene diphosphonite, bis-(2,4-dicumylphenyl)pentaerythritol diphosphite and triaryl phosphite are cited by way of example. Triphenyl phosphine and tris-(2,4-di-tert-butylphenyl)phosphite can particularly preferably be used as stabilisers.

In a further preferred embodiment the top film of the multilayer optical film can contain a coextruded layer in addition to the outer layer. In other words the top film can have a single-layer or multilayer structure. The plastics composition of the outer layer and the coextruded layer can be identically or differently composed. According to a variant according to the invention, the optionally present coextruded layer can contain UV absorbers and/or release agents in addition to the lubricant additive. The plastics composition of the coextruded layer can alternatively also be free from lubricant additive.

In a preferred film structure having at least one coextruded layer in the top film the coextruded layer can preferably be between 10 and 100 μm, particularly preferably between 20 and 50 μm thick.

The films according to the invention can be produced by extrusion or can also be cast from solutions in the form of cast films.

For the purposes of extrusion, polycarbonate pellets can be supplied to an extruder and melted in the plasticising system of the extruder. The plastic melt can then be pushed through a slot die and moulded in that way. The polymer compound can be moulded into the desired final shape in the nip of a polishing calender and its shape fixed by alternate cooling on polishing rolls and in ambient air.

Polycarbonates having a high melt viscosity can conventionally be processed at melt temperatures of 260 to 320° C. The cylinder temperatures of the plasticising cylinder and the die temperatures are adjusted accordingly.

Through the use of one or more ancillary extruders and suitable melt adapters ahead of the slot die, polycarbonate melts of differing composition can be superposed to create multilayer sheets or films, as disclosed for example in EP-A 0 110 221 and EP-A 0 110 238.

The thickness of the complete multilayer optical film in the film structure according to the invention can preferably be 50 μm to 1000 μm, particularly preferably 70 μm to 800 μm and most particularly preferably 100 μm to 700 μm.

The thickness of the outer layer, in other words the layer facing the prism film and/or diffuser film, which contains the lubricant additive, is preferably between 1 μm and 150 μm, by preference 5 μm to 100 μm, particularly preferably 10 μm to 75 μm.

The thickness of the layer or layers of the optical part of the multilayer optical film, which preferably contains no lubricant additive, is preferably between 20 μm and 600 μm.

The multilayer optical film can be produced from the thermoplastic films of the outer layer by lamination or extrusion lamination with an optical base film, for example with a multilayer extrudate according to patent specification U.S. Pat. No. 5,783,28 or laid-open patent applications WO 97/32726 and WO 96/19347, preferably with a multilayer of naphthalene dicarboxylic acid and terephthalic acid polyester.

These multilayer optical films can then subsequently be laid on top of a prism film, for example a known commercial BEF, to form the film structure according to the invention. In addition to good optical properties, such film structures according to the invention also exhibit particularly good quality and optical performance. The films are moreover characterised by good processability and outstanding resistance to scratches and damage.

The present invention also provides a backlight unit for a liquid crystal screen containing the multilayer optical films and film structures according to the invention as described above.

The invention also provides the use of the multilayer optical films and film structures according to the invention as liquid crystal screens.

The examples below are intended to illustrate the invention without, however, limiting its scope.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

### Example 1

### Production of a Polycarbonate Lubricant Additive Masterbatch

The lubricant additive compound (pellets) was produced using a conventional twin-screw compounding extruder at conventional processing temperatures for polycarbonates of 250 to 330° C.

A masterbatch having the following composition was produced:
Makrolon 2600 000000 polycarbonate from Bayer MaterialScience AG in a proportion of 98 wt. %
Diisopropyl dimethylammonium perfluorobutane sulfonate as a colourless powder in a proportion of 2 wt. %.

### Example 2

### Production of an Outer Layer Film

### Film Extrusion:

The unit used to produce the film comprises:
A main extruder having a screw of 105 mm diameter (D) and a length of 41×D; the screw has a vent zone;
An extrusion slot die of width 1500 mm;
A three-roll polishing calender having a horizontal roll configuration, the third roll being able to be tilted +/−45° relative to the horizontal;
A roller conveyor;
A device for the two-sided application of protective film;
A take-off unit;
A winding station.

The following process parameters were chosen:

TABLE 1

| Temperature of main extruder | 275° C. +/− 5° C. | |
|---|---|---|
| Temperature of coextruder | 260° C. +/− 5° C. | |
| Temperature of crosshead | 285° C. +/− 5° C. | |
| Temperature of nozzle | 300° C. +/− 5° C. | |
| Speed of main extruder | 45 | rpm |
| Speed of coextruder | 12 | rpm |
| Temperature of rubber roll 1 | 24° | C. |
| Temperature of roll 2 | 72° | C. |
| Temperature of roll 3 | 131° | C. |
| Take-off speed | 21.5 | m/min |

A compound (pellets) having the following composition was mixed:
Makrolon 3018 550115 polycarbonate from Bayer MaterialScience AG in a proportion of 80.0 wt. %
Lubricant additive masterbatch according to Example 1 in a proportion of 20.0 wt. %.

The polymer pellets were supplied to the feed hopper of the extruder. Melting and conveying of the material took place in the cylinder/screw plasticising system of the extruder. The material melt was supplied to the polishing calender, whose rolls were heated to the temperature specified in Table 1. The final shaping and cooling of the film took place on the polishing calender (comprising three rolls). A textured rubber roll and a steel roll were used to texture the surface of the film. The rubber roll used to texture the film surface is disclosed in U.S. Pat. No. 4,368,240 by Nauta Roll Corporation. Texturing produces a particular roughness of the film surface. The film was then conveyed through a take-off unit. A PE protective film can then be applied to both sides and the film can be wound up. The protective film can subsequently be removed from one side and it can be laminated onto the base film.

A textured steel roll and a textured rubber roll were used in the polishing unit and a polycarbonate film having a thickness of 130 μm and a textured surface on both sides was produced.

### Example 3

### Production of an Outer Layer Film

A compound having the following composition was mixed:
Makrolon polycarbonate 3108 550115 from Bayer MaterialScience AG in a proportion of 80.0 wt. %
Lubricant additive masterbatch according to Example 1 in a proportion of 20.0 wt. %.

A textured steel roll and a rubber roll were used in the polishing unit and a film having a thickness of 130 μm and a textured surface on both sides was produced.

Steel and rubber embossing rolls were therefore used for texturing, such that in the films according to the invention the first side was embossed by the rubber roll and the second side by the steel roll, such that they have differing roughness values (see Table 2).

### Example 4

### Not According to the Invention

As a sample for comparison with Examples 2 and 3 a compound having the following composition without lubricant additive was mixed:
Makrolon polycarbonate 3108 550115 from Bayer MaterialScience AG in a proportion of 100.0 wt. %.

A textured steel roll and a rubber roll were used in the polishing unit and a film having a thickness of 130 μm and a textured surface on both sides was produced.

### Example 5

### Production of a Multilayer Optical Film

An outer layer film according to the invention from Example 2 was laminated onto both sides of a multilayer base film consisting of naphthalene dicarboxylic acid and terephthalic acid polyester.

### Prism Films Used:

### Prism Film 1:

BEF III T 90/50: commercial brightness enhancement film from the Vikuiti® product range from 3M

### Prism Film 2:

BEF II T 90/50: commercial brightness enhancement film from the Vikuiti® product range from 3M

The following prior art films were used as further comparative samples for the outer layer films and multilayer optical films according to the invention:

### Comparative Sample 1

DBEF D 400: commercial dual brightness enhancement film from the Vikuiti® product range from 3M. The film consists of a polycarbonate film textured on the outer side and a multilayer film in the middle. In a conventional film set of a backlight unit the DBEF D400 film is positioned on the aforementioned prism films (BEF) 1 or 2.

### Comparative Sample 2

Makrofol DE 1-4, 125 μm: commercial polycarbonate film from Bayer MaterialScience AG; 1^{st} side smooth; 4^{th} side finely textured.

### Comparative Sample 3

Makrofol DE 6-2, 125 μm: commercial polycarbonate film from Bayer MaterialScience AG; 6^{th} side (second steel roll side) matt textured; 2^{nd} side (first rubber roll side) finely textured.

TABLE 2
Roughness measurements

| | | R3z | R3z |
|---|---|---|---|
| Measured film | | First side | Second side |
| Comparative | Not according to | 9.51 | 9.51 |
| sample 1 (DBEF) | the invention | | |
| Comparative | Not according to | <1 | 6.6 |
| sample 2 | the invention | | |
| | | R3z | R3z |
| | | First side | Second side |
| | | (rubber roll) | (steel roll) |
| Comparative | Not according to | 7.7 | 15.3 |
| sample 3 | the invention | | |
| Example 2 | According to the | 7.9 | 8.6 |
| | invention | | |
| Example 3 | According to the | 6.7 | 8.7 |
| | invention | | |
| Example 4 | Not according to | 6.2 | 9.5 |
| | the invention | | |
| Example 5 | According to the | 7.9 | 8.6 |
| | invention | | |

The roughness was determined in accordance with ISO 4288.

### Determining the Coefficients of Friction:

The coefficient of sliding friction was determined in accordance with ASTM D 1894-06. The surfaces of the first side (see Table 2 above) of the films were used in each case.

### Conditions:

Measuring temperature: 23° C.
Friction block 50 mm
Weight of friction block 202.2 g

### Specimens Width: 60 mm

Length: 200 mm

| Film and side (see | Prism film 1 (friction | Coefficient of |
|---|---|---|
| Table 2) | partner) | sliding friction |
| Comparative sample 1 | BEF III 90/50 | 0.30 |
| (DBEF) | Parallel to prism structure | |
| First side | | |
| Example 3 | BEF III T 90/50 | 0.25 |
| First side | Parallel to prism structure | |
| Example 4 | BEF III T 90/50 | 0.28 |
| First side | Parallel to prism structure | |
| Example 5 | BEF III T 90/50 | 0.24 |
| First side | Parallel to prism structure | |
| | Prism film 1 (friction | Coefficient of |
| Film and side | partner) | sliding friction |
| Comparative sample 1 | BEF III T 90/50 | 0.32 |
| (DBEF) | Transverse to prism | |
| First side | structure | |
| Example 3 | BEF III T 90/50 | 0.30 |
| First side | Transverse to prism | |
| | structure | |
| Example 4 | BEF III T 90/50 | 0.33 |
| First side | Transverse to prism | |
| | structure | |
| Example 5 | BEF III T 90/50 | 0.29 |
| First side | Transverse to prism | |
| | structure | |
| Film and side (see | Prism film 2 (friction | Coefficient of |
| Table 2) | partner) | sliding friction |
| Comparative sample 2 | BEF II T 90/50 | 0.31 |
| (DBEF) | Parallel to prism structure | |
| First side | | |
| Comparative sample 3 | BEF II T 90/50 | 0.34 |
| First side | Parallel to prism structure | |
| Example 2 | BEF II T 90/50 | 0.25 |
| First side | Parallel to prism structure | |
| | Prism film 2 (friction | Coefficient of |
| Film and side | partner) | sliding friction |
| Comparative sample 2 | BEF II T 90/50 | 0.34 |
| (DBEF) | Transverse to prism | |
| First side | structure | |
| Comparative sample 3 | BEF II T 90/50 | 0.38 |
| First side | Transverse to prism | |
| | structure | |
| Example 2 | BEF II T 90/50 | 0.30 |
| First side | Transverse to prism | |
| | structure | |

In summary, optical film structures are produced according to the invention which exhibit improved properties and are particularly suitable for use in liquid crystal flat screens.

1. A film structure comprising at least one prism film and/or diffuser film and a multilayer optical film, wherein said multilayer optical film comprises at least one top film having an outer layer which is directed towards said at least one prism film and/or diffuser film and is prepared from a plastics composition comprising a transparent thermoplastic and at least one quaternary ammonium salt of a perfluoroalkylsulfonic acid as lubricant additive, wherein said outer layer has at least one coefficient of sliding friction of less than 0.30 relative to said at least one prism film and/or diffuser film measured in accordance with ASTM D 1894-06, with a roughness R3z of greater than 5 μm measured in accordance with ISO 4288.

2. The film structure of claim 1, wherein said at least one prism film has a prism structure oriented towards said multilayer optical film and the outer layer of said multilayer optical film has a coefficient of sliding friction of less than or equal to 0.25 parallel to said prism structure of said at least one prism film and a coefficient of sliding friction of less than or equal to 0.30 transversely to said prism structure of said at least one prism film, measured in each case in accordance with ASTM D 1894-06, with a roughness R3z of greater than 5 μm (R3z in accordance with ISO 4288).

3. The film structure of claim 1, wherein said multilayer optical film comprises an optical base film comprising a multilayer consisting of naphthalene dicarboxylic acid and/or terephthalic acid polyester.

4. The film structure of claim 1, wherein said plastics composition contains from 96 to 99.89 weight % of a transparent thermoplastic and from 0.001 to 4.0 weight % of quaternary ammonium salts of perfluoroalkylsulfonic acids as lubricant additive, wherein the total weight % of these components equals 100 weight %.

5. The film structure of claim 1, wherein said transparent thermoplastic is selected from the group consisting of polyacrylates, polymethacrylates, cycloolefin copolymers, polysulfones, polystyrenes, poly-alpha-methyl styrenes, polyesters, polycarbonates, polycarbonate/polyester blends, polycarbonate/polycyclohexyl methanol cyclohexane dicarboxylate, and polycarbonate/PBT.

6. The film structure of claim 1, wherein one or more of said at least one quaternary ammonium salt of a perfluoroalkylsulfonic acid is of formula (I)
R—SO₃NR′R″R′″R″″ (I)
is used as the lubricant additive, wherein
R is perfluorinated cyclic or linear, branched or unbranched carbon chains having 1 to 30 carbon atoms;
R′ is unsubstituted or halogen-, hydroxy-, cycloalkyl-, or alkyl-substituted, cyclic or linear, branched or unbranched carbon chains having 1 to 30 carbon atoms; and
R″, R′″, and R″″
are, independent of each other, cyclic or linear, branched or unbranched carbon chains having 1 to 30 carbon atoms optionally substituted with halogen, hydroxy, cycloalkyl, or alkyl.

7. The film structure of claim 1, wherein said at least one quaternary ammonium salt of a perfluoroalkylsulfonic acid is selected from the group consisting of:
perfluorooctanesulfonic acid tetrapropylammonium salt,
perfluorobutanesulfonic acid tetrapropylammonium salt,
perfluorooctanesulfonic acid tetrabutylammonium salt,
perfluorobutanesulfonic acid tetrabutylammonium salt,
perfluorooctanesulfonic acid tetrapentylammonium salt,
perfluorobutanesulfonic acid tetrapentylammonium salt,
perfluorooctanesulfonic acid tetrahexylammonium salt,
perfluorobutanesulfonic acid tetrahexylammonium salt,
perfluorobutanesulfonic acid trimethyl neopentylammonium salt,
perfluorooctanesulfonic acid dimethyl diisopropylammonium salt,
perfluorooctanesulfonic acid trimethyl neopentylammonium salt,
perfluorobutanesulfonic acid dimethyl dineopentylammonium salt,
perfluorooctanesulfonic acid dimethyl dineopentylammonium salt,
N-methyl tripropylammonium perfluorobutyl sulfonate,
N-ethyl tripropylammonium perfluorobutyl sulfonate,
tetrapropylammonium perfluorobutyl sulfonate,
dimethyl diisopropylammonium perfluorobutyl sulfonate,
N-methyl tributylammonium perfluorooctyl sulfonate,
cyclohexyldiethylmethylammonium perfluorooctyl sulfonate, and
cyclohexyltrimethylammonium perfluorooctyl sulfonate.

8. The film structure of claim 1, wherein said at least one quaternary ammonium salt of a perfluoroalkylsulfonic acid is diisopropyl dimethylammonium perfluorobutyl sulfonate.

9. The film structure of claim 1, wherein said multilayer optical film has a thickness of from 50 μm to 1000 μm.

10. The film structure of claim 1, wherein said outer layer of said multilayer optical film has a thickness of from 1 μm to 150 μm.

11. The film structure of claim 1, wherein said top film comprises at least one coextruded layer in addition to said outer layer.

12. The film structure of claim 11, wherein said coextruded layer has a thickness of from 10 μm to 100 μm.

13. A backlight unit for a liquid crystal screen comprising the film structure of claim 1.

14. An optical film set for a flat screen comprising the film structure of claim 1.
